(19) United States
(12) Patent Application Publication
(10) Pub. No.: US 2024/0359071 A1
(43) Pub. Date: Oct. 31, 2024

(54) COMBINED CARABINER, BOTTLE OPENER AND TOWEL HOLDER

(71) Applicant: TUMI, INC., Edison, NJ (US)

(72) Inventors: Peter Chang-Lin Wu, Great Neck, NY (US); Victor G. Sanz, Whitehouse Station, NJ (US)

(21) Appl. No.: 18/140,809

(22) Filed: Apr. 28, 2023

(51) Int. Cl. A63B 55/00; A63B 57/20; B67B 7/16

(52) U.S. Cl. CPC A63B 55/408; A63B 57/20; B67B 7/16; A63B 2225/687

(57) ABSTRACT

A device for use with a golf bag includes a loop including a first end, two sides and a second end, which is opposite the first end. The device further includes a movable gate provided on one side of the loop. The movable gate is movable from a biased closed position to an open position. The device further includes a cross member dividing the loop into a first loop and a second loop. The first loop is defined by the cross member, the sides and the first end and the second loop is defined by the cross member, the sides and the second end. The cross member includes a lip configured to function as a bottle opener with the second end. The first loop is configured to receive an item.

### BACKGROUND

The present disclosure relates to accessories used with golf bags, and more particularly to a golf accessory device that embodies a combined carabiner, towel holder and bottle opener for use with a golf bag.

Golf bags are provided to carry items to play golf, such as golf clubs, golf balls, and related equipment. A typically golf bag includes a bag provided with a series of compartmentalized openings that are configured to accept the shafts of golf clubs in the typical manner. The bag includes side walls and a bottom wall. The bag may also include one or more pockets adapted to hold golf accessories, such as golf balls, gloves, and tees.

### SUMMARY OF THE DISCLOSURE

One aspect of the present disclosure is directed to a device for use with a golf bag. In one embodiment, the device comprises a loop including a first end, two sides and a second end, which is opposite the first end, and a movable gate provided on one side of the loop. The movable gate is movable from a biased closed position to an open position. The device further comprises a cross member dividing the loop into a first loop and a second loop. The first loop is defined by the cross member, the sides and the first end and the second loop is defined by the cross member, the sides and the second end. The cross member includes a lip configured to function as a bottle opener with the second end. The first loop is configured to receive an item.

Embodiments of the device further may include the lip of the cross member extending at an angle with respect to a plane of the device. The lip may be configured to engage an edge of a bottle cap to remove the bottle cap. The second loop may be configured to receive a strap of the golf bag to permanently secure the device to the golf bag. The device may be fabricated from a metal material including zinc die cast material. The loop may be ridged. The loop may be elongate in shape including two long straight sides connected to the first end and the second end. The first end may be semi-circular and the second end is squared-off. The second loop may be smaller than the first loop. The movable gate may be a spring-loaded gate. The second loop may be configured to open to enable the device to be attached to the golf bag. The cross member may be a first cross member. The device further may include a second cross member extending between the sides, with the second cross member further dividing one of the first loop and the second loop. The movable gate may be a first movable gate. The device further may include a second movable gate provided on one side of the loop, with the second movable gate being movable from a biased closed position to an open position.

Another aspect of the present disclosure is directed to a golf bag including the device. The golf bag further includes a strap configured to secure the device to the golf bag. The strap may be fabricated from reinforced cloth material.

A method of removing a bottle cap from a bottle with the device is further disclosed.

One end of the spring loaded gate includes a pivot pin to secure the gate to the side of the device and a spring to provide a bias of the gate to the closed position.

An opposite other end of the spring loaded gate includes a latch element that is configured to receive a mating latch element of the side of the device to secure the gate in place in the closed position.

The spring-loaded gate includes an integrally formed gate that is biased to an outboard position with respect to the side of the device.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a perspective view of a golf bag having a device embodying a combined carabiner, bottle opener and towel holder of an embodiment of the present disclosure;

FIG. 2A is an enlarged perspective view of the device showing a spring-loaded gate in a closed position;

FIG. 2B is an enlarged perspective view of the device showing the spring-loaded gate in an open position;

FIG. 3A is a front view of the device;

FIG. 3B is a side view of the device;

FIG. 4A is a cross-sectional view of the device taken along line 4A in FIG. 3B;

FIG. 4B is a cross-sectional view of the device taken along line 4B in FIG. 4A;

FIG. 5 is a front view of a device embodying a combined carabiner, bottle opener and towel holder of another embodiment of the present disclosure; and

FIG. 6 is a front view of a device embodying a combined carabiner, bottle opener and towel holder of yet another embodiment of the present disclosure.

### LIST OF REFERENCE NUMERALS UTILIZED IN THE DRAWINGS

With regard to reference numerals used, the following numbering is used throughout the description and drawings. Where technical features in the figures or detailed description are followed by these reference numerals, the reference numerals have been included for the sole purpose of increasing the intelligibility of the figures or detailed description. Accordingly, neither the reference numerals nor their absence is intended to have any limiting effect on the scope of any claim elements. In the figures, each identical or nearly identical component that is illustrated in various figures is represented by a like numeral. For purposes of clarity, not every component may be labeled in every figure.
Reference numeral 10 refers to a golf bag;
Reference numeral 12 refers to an open end of the golf bag;
Reference numeral 14 refers to a closed end of the golf bag;
Reference numeral 16 refers to a pocket or compartment of the golf bag;
Reference numeral 18 refers to a stand mechanism of the golf bag;
Reference numeral 20 refers to a handle of the golf bag;
Reference numeral 22 refers to a towel;
Reference numeral 30 refers to a device that functions as a combined carabiner, bottle opener and towel holder;
Reference numeral 32 refers to a strap of the golf bag;
Reference numeral 34 refers to an elongated loop of the device;
Reference numeral 36 refers to a semi-circular end of the elongated loop;
Reference numeral 38 refers to a side of the elongated loop;
Reference numeral 40 refers to an opposite side of the elongated loop;
Reference numeral 42 refers to a squared-off end of the elongated loop;
Reference numeral 44 refers to a spring-loaded gate of the device;
Reference numeral 46 refers to a cross member of the device;
Reference numeral 48 refers to a lip of the cross member;
Reference numeral 50 refers to a first loop of the elongated loop;
Reference numeral 52 refers to a second loop of the elongated loop;
Reference numeral 54 refers to a pivot pin used to connect the spring-loaded gate;
Reference numeral 56 refers to a spring used to bias the spring-loaded gate;
Reference numeral 58 refers to a latch element of the spring-loaded gate;
Reference numeral 60 refers to a mating latch member of the elongated loop;
Reference numeral 62 refers to a space on the device for a label;
Reference numeral 70 refers to another device that functions as a combined carabiner, bottle opener and towel holder;
Reference numeral 74 refers to an elongated loop of the device;
Reference numeral 76 refers to a semi-circular end of the elongated loop;
Reference numeral 78 refers to a side of the elongated loop;
Reference numeral 80 refers to an opposite side of the elongated loop;
Reference numeral 82 refers to a squared-off end of the elongated loop;
Reference numeral 84 refers to a first spring-loaded gate of the device;
Reference numeral 86 refers to a cross member of the device;
Reference numeral 88 refers to a lip of the cross member;
Reference numeral 90 refers to a first loop of the elongated loop;
Reference numeral 92 refers to a second loop of the elongated loop;
Reference numeral 94 refers to a second spring-loaded gate of the device;
Reference numeral 100 refers to yet another device that functions as a combined carabiner, bottle opener and towel holder;
Reference numeral 104 refers to an elongated loop of the device;
Reference numeral 106 refers to a semi-circular end of the elongated loop;
Reference numeral 108 refers to a side of the elongated loop;
Reference numeral 110 refers to an opposite side of the elongated loop;
Reference numeral 112 refers to a squared-off end of the elongated loop;
Reference numeral 114 refers to a spring-loaded gate of the device;
Reference numeral 116 refers to a first cross member of the device;
Reference numeral 118 refers to a lip of the cross member;
Reference numeral 120 refers to a first loop of the elongated loop;
Reference numeral 122 refers to a second loop of the elongated loop;
Reference numeral 124 refers to a third loop of the elongated loop; and
Reference numeral 126 refers to a second cross member of the device.

### DETAILED DESCRIPTION OF THE DISCLOSURE

For the purposes of illustration only, and not to limit the generality, the present disclosure will now be described in detail with reference to the accompanying figures. This disclosure is not limited in its application to the details of construction and the arrangement of components set forth in the following description or illustrated in the drawings. The principles set forth in this disclosure are capable of other embodiments and of being practiced or carried out in various ways. Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Embodiments of the present disclosure are directed to a device that offers a combined carabiner, bottle opener and towel or another accessory holder. In certain embodiments the device can be fabricated from ridged material, such as zinc alloy, aluminum, aluminum alloy or stainless steel. The device is configured to be secured to a golf bag and serve many functions including the ability to secure a towel to the golf bag, the ability to open a bottle having a cap, and the ability to secure other items, such as keys.

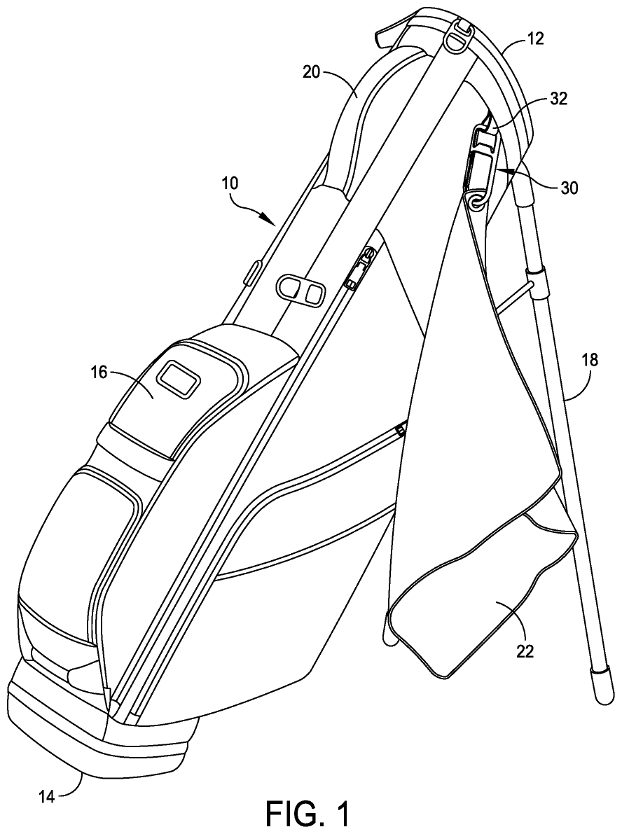

Referring to the drawings, and more particularly to FIG. 1, a golf bag of an exemplary and non-limiting design is generally indicated at 10. In the shown embodiment, the golf bag 10 includes an open top end 12 configured to receive shafts of golf clubs, a closed bottom end 14, and several compartments or pockets, e.g., pocket 16, having zippers to store items in the compartments. The golf bag 10 further includes a stand mechanism 18 having legs that enable the golf bag to be placed in an upright position, which is shown in FIG. 1. The golf bag 10 further includes a variety of straps, handles, e.g., handle 20, and harnesses (not shown) to enable the golf bag to be picked up and carried by its owner or caddie. Further, as will be described in greater detail below, the golf bag 10 can be configured to support accessories, such as towel 22, which is used by golfers to clean golf clubs, for example.

Further referring to FIG. 1, the golf bag includes a device, generally indicated at 30, which functions as a combined connector, e.g., a carabiner, bottle opener and towel holder. In the shown embodiment, the device 30 is secured to the golf bag 10 by a strap 32, which connection will be described in greater detail below. As shown, the device 30 is configured to support an accessory, such as towel 22. The device 30 can however alternatively or additionally support other accessories or things as well, especially accessories having a loop, such as car key holders.

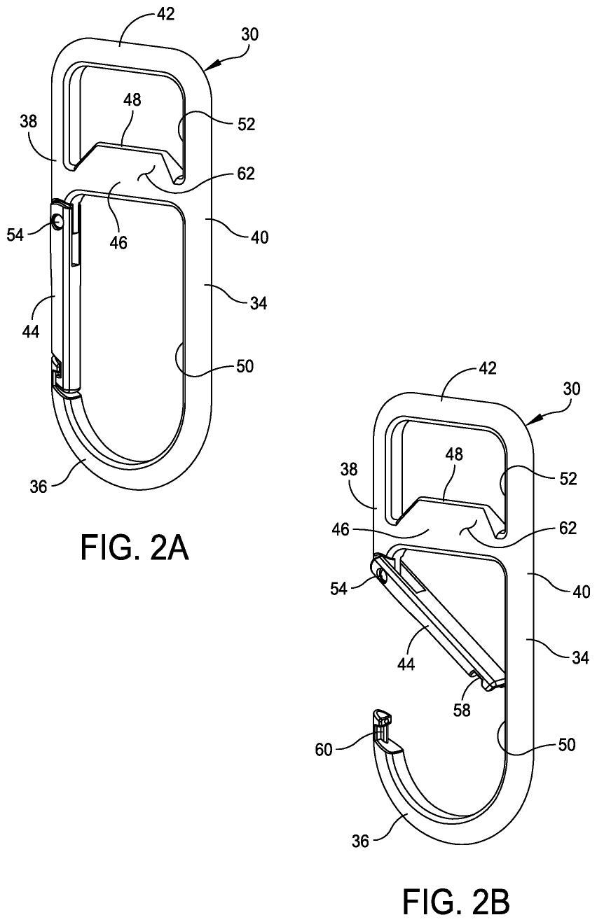

Referring to FIGS. 2A and 2B, the device 30 includes a metal structure that embodies an elongated loop or ring 34, although the device could be fabricated from plastic or reinforced plastic. As shown, the elongated loop 34 includes a semi-circular end 36, two long relatively straight sides 38, 40, and a squared-off end 42. One side 38 of the elongated loop 34 includes a spring-loaded gate 44 that functions as a carabiner. The spring-loaded gate 44 is movable from a biased closed position (FIG. 2A) to an open position (FIG. 2B) against a bias applied to the spring-loaded gate. As shown, the spring-loaded gate 44 is pressed inwardly toward the other side of the device to achieve the open position shown in FIG. 2B.

As is known, a carabiner is a specialized type of connector, including a metal loop with a spring-loaded gate provided to connect components quickly and reversibly. Carabiners are typically fabricated from aluminum alloys and/or stainless steel, and are lightweight. Carabiners can be provided in several shapes, namely oval-shaped, D-shaped, offset D-shaped and pear-shaped. Carabiners can be locking or non-locking. In one embodiment, the carabiner is non-locking, having the spring-loaded gate that accepts a ring from a towel, for example. The shown gate is solid, but can be fabricated from wire.

As noted above, the carabiner function, i.e., the spring-loaded gate 44, of the device 30 is primarily provided to secure accessories to the device, such as towel 22. In one embodiment, the towel 22 can be configured with a hook or grommet to be secured to the device 30 by opening the spring-loaded gate 44 and accepting the hook or grommet to releasably secure the towel to the device. Any number of accessories can be secured to the device 30 in place of or in addition to the towel 22. One such accessory is a club cleaning brush having a hook or loop that can be secured to the device in a similar manner. Other items can be secured to the device, including key rings or an accessory pouch that is configured to carry larger items, such as a wallet or a cell phone.

In another embodiment, the carabiner function of the device 30 enables the device to be releasably attached to straps or closed loops provided on the golf bag. For example, when strap 32 is not provided, the spring-loaded gate 44 can be opened by hand to achieve the open position shown in FIG. 2B to secure the device on a loop or strap provided on the golf bag 10. Once secured, accessories, such as towel 22, can be secured to the device 30.

Although the device 30 of the shown embodiment includes long relatively straight sides 38, 40, it should be understood that the device can embody any shape and still fall within the scope of the present disclosure. For example, the sides extending from the semi-circular end 36 to the squared-off end 42 can be shaped to create a circular shape or an oval shape.

The device 30 further includes a cross member 46 that is secured to or integrally part of the long sides 38, 40 of the device. As shown, the cross member 46 extends perpendicularly from one long side 38 to the other long side 40 of the device 30, with the cross member being positioned closer to the squared-off end 42 for the reasons provided below. The cross member 46 includes a lip 48, which in one embodiment, has angled surfaces that lead to a narrow or thin edge. This lip 48 is provided to engage an edge of a bottle cap to remove the bottle cap from the bottle on which it is secured. The cross member 46 having lip 48, along with the squared-off end 42 of the device 30 functions as a bottle cap opener to enable the removal of metal bottle caps from glass bottles.

As is known, a metal bottle cap is secured to a rim of the neck of a glass bottle by being pleated or ruffled around the rim of the bottle. The bottle opener function of the device 30 uses the lip 48 of the device as a lever by inserting the lip beneath the pleated metal edge of the bottle cap, and uses the squared-off end 42 as a leverage point on the bottle cap, which functions as a fulcrum about which the device is pivoted. The size and length of the device 30 can be optimized to attain leverage when removing a bottle cap.

In one embodiment, the cross member 46 divides the elongated loop 34 into a first loop 50 and a second loop 52. The first loop 50 is defined by the cross member 46, a portion of the sides 38, 40 and the semi-circular end of the device 36. The spring-loaded gate 44 is provided as part of the first loop 50. The second loop 52 is defined by the cross member 46, a portion of the sides 38, 40 and the squared-off end 42 of the device 30. As noted above, since the cross member 46 is positioned closer to the squared-off end 42 of the device 30, the first loop 50 is larger than the second loop 52, with the first loop being able to accommodate a number of items that are secured to the device. When using the device 30 as a bottle opener, the portion of the device defined by the first loop is grasped by the user to remove the bottle cap.

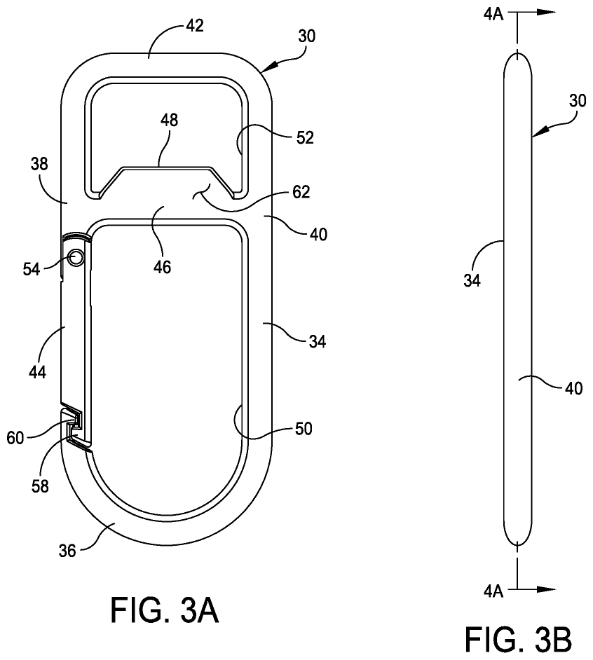

Referring additionally to FIGS. 3A and 3B, and particularly FIG. 3A, in one embodiment, the space between the cross member 46 and the squared-off end 42 can be sized to receive the strap 32 of the golf bag as shown in FIG. 1 to permanently secure the device 30 to the golf bag 10. The strap 32 is shown to surround the squared-off end 42 with the material of the strap being disposed within the space provided between the squared-off end 42 and the cross member 46 as defined by the second loop 52. The strap 22 can be made of rugged or reinforced cloth material or suitable plastic material that is sufficiently strong enough to secure the device 30 to the golf bag 10. In another embodiment, the strap 22 may be secured to the device 30 by inserting the open loop of the strap over the semi-circular end 36 of the device 30 when the spring-loaded gate 44 is opened. FIG. 3B illustrates the device 30 from a side view showing the thin or narrow construction of the device.

The strap 22 makes it easier when performing the bottle opening function of the device 30. Specifically, the edge of the bottle cap is engaged by lip 48 of the cross member 46 and the strap 22 and squared-off end 42 engage the body of the bottle cap. Once the lip 48 is positioned to engage the edge of the bottle cap, the user can rotate the bottle in a direction away from the bottle cap, with the strap 22 holding the device 30 in place to create sufficient leverage to remove the bottle cap.

In one embodiment, to remove the bottle cap from the bottle, the user holds the bottle with one hand and the device 30 with the other hand. The bottle is gripped by the base of the bottle, with the device 30 being held near the semi-circular end 36 so that the squared-off end 42 and the cross member 46 and the lip 48 are exposed. The lip 48 is wedged underneath the edge of the bottle cap. The user can view the bottle cap through an opening formed between the cross member 46 and the squared-off end 42. After the lip 48 is wedged under the edge of the bottle cap, the opposite edge of the opening defined by the squared-off end 42 engaged the top of the bottle cap. In this position, the user lifts the device 30 so that the squared-off end 42 of the device presses down on top of the bottle cap. At the same time, the lip 48 of the cross member engages and lifts the side of the bottle cap thereby causing the bottle cap to bend upward and pop off of the bottle.

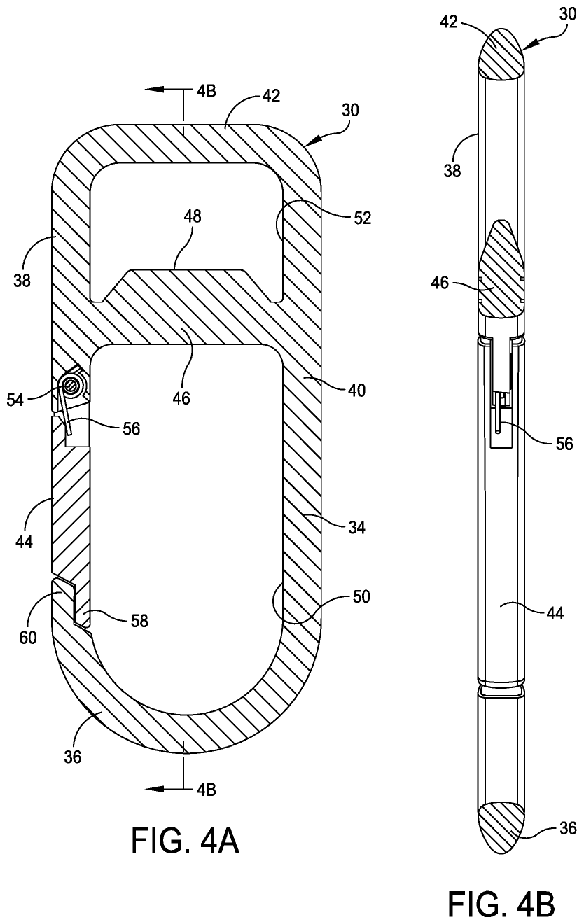

Referring additionally to FIGS. 4A and 4B, one end of the spring-loaded gate 44 includes a pivot pin 44 to secure the gate to the side 38 of the device 30 and a spring 56 to provide a bias of the gate to the shown closed position. In one embodiment, the spring 56 is fabricated from spring steel. The other end of the spring-loaded gate 44 includes a latch element 58 that is configured to receive a mating latch element 60 formed on a side 40 of the device 30 to secure the gate in place in the shown closed position. The latch element 58 and the mating latch element 60 are configured to interconnect to create a relatively uniform surface along the elongated body 34 formed between the semi-circular end 36 and the straight side 38.

In one embodiment, as shown in FIGS. 2A, 2B and 3A, the cross member 46 of the device 30 can include a space 62 for a label. This space 62 may be used for advertising or brand recognition.

Embodiments of the device 30 may be varied to have different shapes and sizes. For example, the length of the device 30 may be varied to accommodate the securement of accessories to the device.

In one embodiment, the device 30 is 5 millimeters (mm) in thickness, having an overall length of 88.5 mm and a width of 38 mm. The smaller second loop 52 is sized to effectively perform the bottle opening function, having a width of 27 mm and depth of 15 mm.

In another embodiment, the device 30 may be fabricated from a suitable zinc die cast material. In other embodiments, the device 30 may be fabricated from any desired material to increase the strength (e.g., stainless steel) or decrease the weight and cost (e.g., aluminum alloy) of the device.

In another embodiment, the spring-loaded gate 44 of the device 30 may be configured to include a spring clip having an integrally formed gate that is biased to an outboard position with respect to the side of the device. An end of the gate is held in place by an end of the side of the device to hold the gate in place in the closed position.

In another embodiment, when fabricating the device 30 from an aluminum alloy or even a hard plastic material, the cross member can have a metal, e.g., stainless steel, insert so that when the device is used as a bottle opener, the device is sufficiently strong enough to perform the bottle cap removal function.

In one embodiment, the device 30 can have the carabiner function provided on the side of the device as part of the smaller opening, i.e., the second loop 52. Specifically, the spring-loaded gate 44 of the device 30 can be positioned adjacent the squared-off end 42, with the length between the cross member 46 and the squared-off end being lengthened to accommodate the spring-loaded gate.

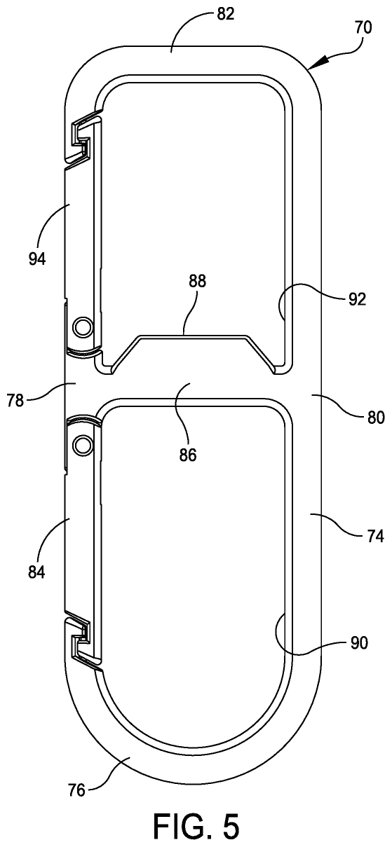

Referring to FIG. 5, in a certain embodiment, a device, generally indicated at 70, is provided to function as a combined a carabiner, bottle opener and towel holder. As with device 30, the device 70 is secured to the golf bag by a strap and is configured to support an accessory, such as a towel. The device 70 includes an elongated loop 74 having a semi-circular end 76, two long straight sides 78, 80, and a squared-off end 82. The device 70 further includes a cross member 86 that is secured to or integrally part of the long sides 78, 80 of the device. As shown, the cross member 86 extends perpendicularly from one long side 78 to the other long side 80 of the device 70, with the cross member being positioned slightly closer to the squared-off end 82 for the reasons provided below. The cross member 86 includes a lip 88, which in one embodiment, has angled surfaces that lead to a narrow or thin edge. This lip 88 is provided to engage an edge of a bottle cap to remove the bottle cap from the bottle on which it is secured, similar to lip 48 of cross member 46 of device 30.

In the shown embodiment, the cross member 86 of the device 70 divides the elongated loop 84 into a first loop 90 and a second loop 92. The first loop 90 is defined by the cross member 86, a portion of the sides 78, 80 and the semi-circular end 76 of the device 70. The second loop 90 is defined by the cross member 86, a portion of sides 78, 80 and the squared-off end 82. The device 70 further includes a first spring-loaded gate 84 provided on one side 78 within the first loop 90 of the device 70 to function as a first carabiner. As with spring-loaded gate 44 of device 30, the spring-loaded gate 84 is movable from a biased closed position (shown in FIG. 5) to an open position (not shown) against a bias applied to the spring-loaded gate. As noted above, the carabiner function, i.e., the spring-loaded gate 84, of the device 70 is primarily provided to secure accessories to the device. The construction of spring-loaded gate 84 is substantially similar if not identical to the construction of spring-loaded gate 44 of device 30.

The device 70 further includes a second spring-loaded gate 94 provided on one side, e.g., side 78, within the second loop 92 of the device 70 to function as a second carabiner. The construction of the second spring-loaded gate 94 is substantially similar if not identical to the construction of spring-loaded gate 84. Further, it should be noted that the second spring-loaded gate 94 can be provided on the other side 80 of the elongated loop 74.

As noted above, since the cross member 86 is positioned slightly closer to the squared-off end 82 of the device 70, the first loop 90 is larger than the second loop 92. When using the device 70 as a bottle opener, the portion of the device defined by the first loop 90 is grasped by the user to remove the bottle cap.

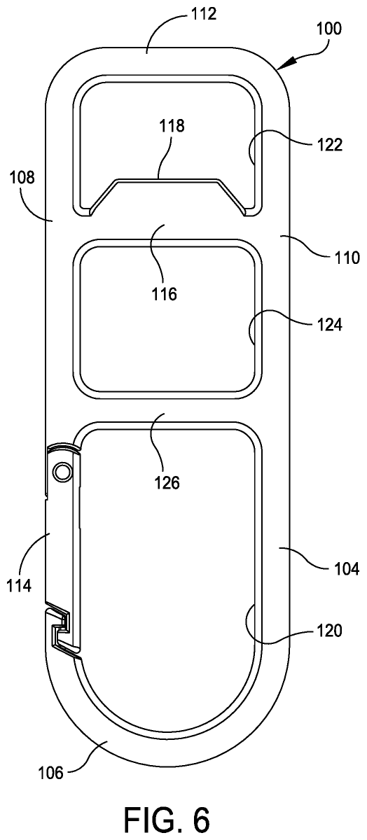

Referring to FIG. 6, in another embodiment, a device, generally indicated at 100, is provided to function as a combined a carabiner, bottle opener and towel holder. As with devices 30, 70, the device 100 is secured to the golf bag by a strap and is configured to support an accessory, such as a towel. The device 100 includes an elongated loop 104 having a semi-circular end 106, two long straight sides 108, 110, and a squared-off end 112. The device 100 further includes a first cross member 116 that is secured to or integrally part of the long sides 108, 110 of the device. As shown, the first cross member 116 extends perpendicularly from one long side 108 to the other long side 110 of the device 100. The first cross member 116 includes a lip 118, which in one embodiment, has angled surfaces that lead to a narrow or thin edge. This lip 118 is provided to engage an edge of a bottle cap to remove the bottle cap from the bottle on which it is secured, similar to lip 48 of cross member 46 of device 30 and to lip 88 of cross member 86 of device 70.

The device 100 further includes a second cross member 126, which is spaced from the first cross member 116 and is secured to or integrally part of the long sides 108, 110 of the device. As with the first cross member 116, the second cross member 126 extends perpendicularly from one long side 108 to the other long side 110 of the device 100. As shown, the second cross member 126 does not include a lip to perform the bottle cap opening function, but could be configured with such a lip that extends towards the semi-circular end 106 of the device.

In the shown embodiment, the first cross member 116 and the second cross member 126 of the device 100 divides the elongated loop 104 into a first loop 120, a second loop 122 and a third loop 124. The first loop 120 is defined by the second cross member 126, a portion of the sides 108, 110 and the semi-circular end 106 of the device 100. The second loop 122 is defined by the first cross member 116, a portion of sides 108, 110 and the squared-off end 112. The third loop 124 is defined by the first cross member 116, a portion of sides 108, 110 and the second cross member 126.

The device 100 further includes a spring-loaded gate 114 provided on one side 108 within the second loop 122 of the device 100 to function as a carabiner. As with spring-loaded gate 44 of device 30, the spring-loaded gate 114 is movable from a biased closed position (shown in FIG. 6) to an open position (not shown) against a bias applied to the spring-loaded gate. As noted above, the carabiner function, i.e., the spring-loaded gate 114, of the device 100 is primarily provided to secure accessories to the device. The construction of spring-loaded gate 114 is substantially similar to the construction of spring-loaded gate 44 of device 30.

### ENUMERATED EMBODIMENTS

1. A device (30) for use with a golf bag (10), the device (30) comprising:
a loop (34) including a first end (36), two sides (38, 40) and a second end (42), which is opposite the first end (36);
a movable gate (44) provided on one side (38) of the loop (34), the movable gate (44) being movable from a biased closed position to an open position; and
a cross member (46) dividing the loop (34) into a first loop (50) and a second loop (52), the first loop (50) being defined by the cross member (46), the sides (38, 40) and the first end (36) and the second loop (52) being defined by the cross member (46), the sides (38, 40) and the second end (42), the cross member (46) including a lip (48) configured to function as a bottle opener with the second end (42),
wherein the first loop (50) is configured to receive an item.

2. The device (30) of claim 1, wherein the lip (48) of the cross member (46) extends at an angle with respect to a plane of the device (30), the lip (48) being configured to engage an edge of a bottle cap to remove the bottle cap.

3. The device (30) of claim 1 or 2, wherein the second loop (52) is configured to receive a strap (32) of the golf bag (10) to permanently secure the device (30) to the golf bag (10).

4. The device (30) of any preceding claim, wherein the device (30) is fabricated from a metal material including zinc die cast material.

5. The device (30) of any preceding claim, wherein the loop (34) is ridged.

6. The device (30) of any preceding claim, wherein the loop (34) is elongate in shape including two long straight sides (38, 40) connected to the first end (36) and the second end (42).

7. The device (30) of claim 6, wherein the first end (36) is semi-circular and the second end (42) is squared-off.

8. The device (30) of claim 6 or 7, wherein the second loop (52) is smaller than the first loop (50).

9. The device (30) of any preceding claim, wherein the movable gate (44) is a spring-loaded gate.

10. The device (30) of any preceding claim, wherein the second loop (52) is configured to open to enable the device to be attached to the golf bag (10).

11. The device (30) of claim 1, wherein the cross member (46) is a first cross member, the device (30) further comprising a second cross member extending between the sides (38, 40), the second cross member further dividing one of the first loop (50) and the second loop (52).

12. The device (30) of claim 1, wherein the movable gate is a first movable gate, wherein the device (30) further comprises a second movable gate provided on one side of the loop, the second movable gate (44) being movable from a biased closed position to an open position.

13. A golf bag (10) including the device (30) of any preceding claim, the golf bag (10) including a strap (32) configured to secure the device (30) to the golf bag (10).

14. The golf bag (10) of claim 12, wherein the strap (32) is fabricated from reinforced cloth material.

15. A method of removing a bottle cap from a bottle with the device (30) of claims 1 and 2.

Having thus described several aspects of at least one embodiment of this disclosure, it is to be appreciated various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

What is claimed is:

1. A device for use with a golf bag, the device comprising:
a loop including a first end, two sides and a second end, which is opposite the first end;
a movable gate provided on one side of the loop, the movable gate being movable from a biased closed position to an open position; and
a cross member dividing the loop into a first loop and a second loop, the first loop being defined by the cross member, the sides and the first end and the second loop being defined by the cross member, the sides and the second end, the cross member including a lip configured to function as a bottle opener with the second end,
wherein the first loop is configured to receive an item.

2. The device of claim 1, wherein the lip of the cross member extends at an angle with respect to a plane of the device, the lip being configured to engage an edge of a bottle cap to remove the bottle cap.

3. The device of claim 1, wherein the second loop is configured to receive a strap of the golf bag to permanently secure the device to the golf bag.

4. The device of claim 1, wherein the device is fabricated from a metal material including zinc die cast material.

5. The device of claim 1, wherein the loop is ridged.

6. The device of claim 1, wherein the loop is elongate in shape including two long straight sides connected to the first end and the second end.

7. The device of claim 6, wherein the first end is semi-circular and the second end is squared-off.

8. The device of claim 6, wherein the second loop is smaller than the first loop.

9. The device of claim 1, wherein the movable gate is a spring-loaded gate.

10. The device of claim 1, wherein the second loop is configured to open to enable the device to be attached to the golf bag.

11. The device of claim 1, wherein the cross member is a first cross member, the device further comprising a second cross member extending between the sides, the second cross member further dividing one of the first loop and the second loop.

12. The device of claim 1, wherein the movable gate is a first movable gate, wherein the device further comprises a second movable gate provided on one side of the loop, the second movable gate being movable from a biased closed position to an open position.

13. A golf bag including the device of claim 1, the golf bag including a strap configured to secure the device to the golf bag.

14. The golf bag of claim 13, wherein the strap is fabricated from reinforced cloth material.

15. A method of removing a bottle cap from a bottle with the device of claim 1.
